(19) United States
(12) Patent Application Publication
(10) Pub. No.: US 2013/0000597 A1
(43) Pub. Date: Jan. 3, 2013

(54) LASER IGNITION DEVICE AND OPERATING METHOD FOR A LASER IGNITION DEVICE

(76) Inventors: Martin Weinrotter, Vitoria-Gasteiz (ES); Werner Herden, Gerlingen (DE); Pascal Woerner, Korntal-Muenchingen (DE); Juergen Raimann, Weil Der Stadt (DE)

(21) Appl. No.: 13/517,192

(22) PCT Filed: Nov. 18, 2010
(86) PCT No.: PCT/EP2010/067719

§ 371 Date: Aug. 29, 2012

(30) Foreign Application Priority Data
Dec. 21, 2009 (DE) 10 2009 055 040.2

(51) Int. Cl. F02B 19/12; F02P 23/04

(52) U.S. Cl. 123/253; 123/143 B

(57) ABSTRACT

A laser ignition device, particularly for an internal combustion engine, having a precombustion chamber and a laser device, which is developed to irradiate, particularly to focus, laser radiation onto at least two ignition points, lying in the precombustion chamber, that are different from each other. The laser device is developed to irradiate the laser radiation optionally onto one or more ignition points.

### FIELD OF THE INVENTION

The present invention relates to a laser ignition device, particularly for an internal combustion engine, having a precombustion chamber and having a laser device that is developed to irradiate laser radiation onto at least two ignition points that are different from each other and are each lying in the precombustion chamber. The present invention also relates to an operating method for such a laser ignition device.

### SUMMARY

It is an object of the present invention to further refine a laser ignition device and an operating method for it in such a way that a more flexible operation comes about.

In the case of the laser ignition device of the type mentioned above, this object may be attained, according to an example embodiment of the present invention, in that the example laser device is developed to irradiate the laser radiation optionally onto one or more ignition points. The laser ignition process is thereby advantageously adapted to the respective operating status of the internal combustion engine or to another objective system which includes the laser ignition device according to the present invention. The possibility also exists of influencing the torch range of ignition torches, which, as a result of the laser ignition, proceed from the precombustion chamber through corresponding overflow ducts into a main combustion chamber of the internal combustion engine.

A thermodynamically particularly efficient conversion of the ignitable mixture contained in the precombustion chamber, and with that, also an increased torch range, is given as a result of one advantageous specific embodiment of the present invention, in that the laser device is developed so as to irradiate the laser radiation simultaneously onto a plurality of ignition points.

In one additional particularly advantageous specific embodiment, of the laser ignition device according to the present invention, it is provided that the laser device has at least two laser spark plugs. This means that, according to the present invention, a plurality of laser spark plugs are able to be combined with one another in such a way that they make possible an action of laser ignition pulses, according to the present invention, upon the precombustion chamber.

One particularly favorable distribution of ignition points within the precombustion chamber is implementable as a result of an additional advantageous embodiment of the present invention, in that at least two laser spark plugs have different focal lengths.

Alternatively or supplementarily, the laser ignition device may have, according to an additional specific embodiment, at least one bifocal focusing optics, which while acting, using a laser ignition pulse, upon at least two ignition points that are different from each other, makes possible an appropriate focusing of the laser ignition pulse and the associated laser radiation.

As an additional attainment of the object of the present invention, an example operating method for a laser ignition device is also provided.

Additional features, application options and advantages of the present invention ensue from the following description of exemplary embodiments of the present invention, which are illustrated in the figures. In this context, all described or depicted features, alone or in any desired combination, form the subject matter of the present invention, regardless of their combination in the description below, and irrespective of their wording or illustration in the description and in the figures, respectively.

### BRIEF DESCRIPTION OF THE DRAWINGS

FIG. 1 shows an end section, facing the combustion chamber, of a first specific embodiment of the laser ignition device according to the present invention, in a partial cross section.

FIG. 2 shows a block diagram to illustrate the control principle of the laser ignition device of FIG. 1.

FIG. 3 shows an end section, facing the combustion chamber, of a second specific embodiment of the laser ignition device according to the present invention, in a partial cross section.

### DETAILED DESCRIPTION OF EXAMPLE EMBODIMENTS

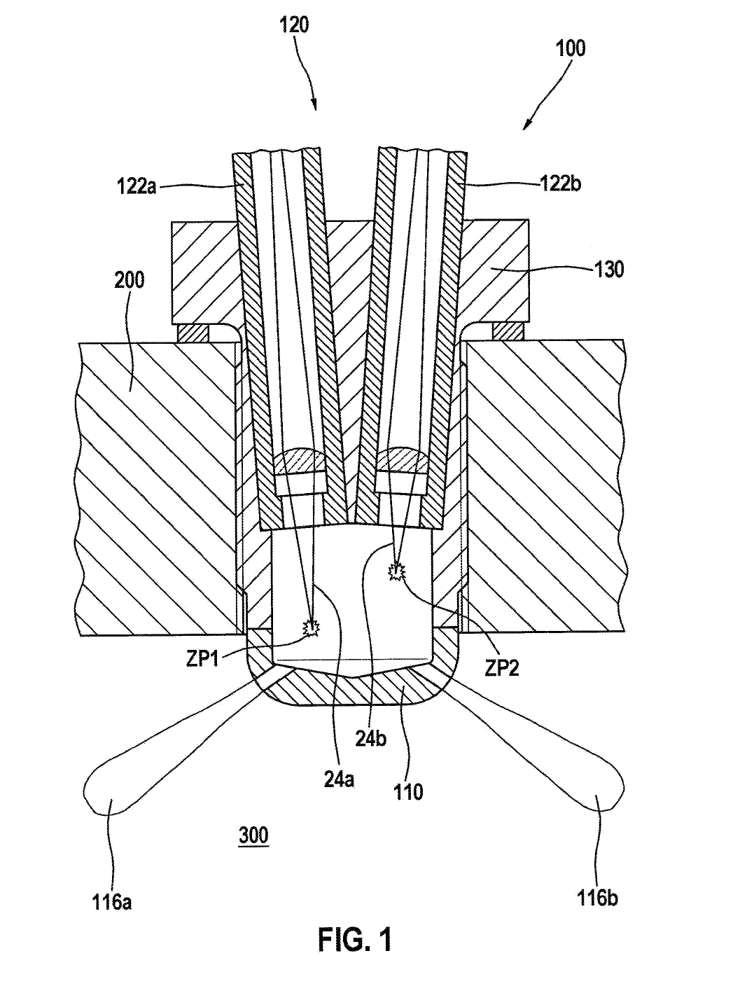

FIG. 1 shows an end section of a first specific example embodiment of the laser ignition device 100 according to the present invention. Laser ignition device 100 has a precombustion chamber 110 and is, in the present case, arranged in a cylinder head 200 of an internal combustion engine in such a way that precombustion chamber 110 projects into a combustion chamber 300 of the internal combustion engine.

Laser ignition device 100 also has a laser device 120, which is developed to irradiate, particularly to focus, laser radiation 24a, 24b onto at least two ignition points ZP1, ZP2, lying in precombustion chamber 110, that are different from each other. Because of this, an ignitable mixture located in precombustion chamber 110 is able to be ignited at two ignition points, in a conventional manner. As a result of the laser ignition in precombustion chamber 110, energy-rich ignition torches 116a, 116b, exit through overflow channels, that are not designated in greater detail, from precombustion chamber 110 into combustion chamber 300 of the internal combustion engine, in order to ignite an ignitable mixture that is present there.

An especially versatile operation of laser ignition device 100, according to the present invention, exists in that laser device 120 is developed to irradiate laser radiation 24a, 24b optionally onto one or more of ignition points ZP1, ZP2. Because of this, the pressure in the precombustion chamber, and thus the torch length, that is, the length of ignition torches 116a, 116b, exiting from precombustion chamber 110, is advantageously able to be controlled.

Consequently, as an example, at high load of the internal combustion engine and a correspondingly great filling of precombustion chamber 110 with ignitable mixture, laser radiation 24a, 24b is only able to be irradiated onto one of the several possible ignition points ZP1, ZP2. The combustion in precombustion chamber 110, because of the large filling, is sufficiently rapid to ensure a sufficiently large torch range for ignition torches 116a, 116b, even in the case of one single ignition point.

At high load of the internal combustion engine and a correspondingly slight filling of precombustion chamber 110 with ignitable mixture, laser radiation 24a, 24b is advantageously irradiated onto both of the several possible ignition points ZP1, ZP2. This state is shown in FIG. 1. Because of the laser ignition in both ignition points ZP1, ZP2, the combustion in precombustion chamber 110 is sufficiently speeded up, in spite of the lesser filling, so that the overpressure increase in precombustion chamber 110 effects a similar torch range for ignition torches 116a, 116b as in the case of a greater filling of precombustion chamber 110.

In a variant of the present invention variant shown in FIG. 1, the possibility of the flexible simple or multiple local laser ignition in precombustion chamber 110 is given in that laser device 120 has two laser spark plugs 122a, 122b, which are integrated into a common housing 130. Analogously, as in usual laser spark plugs, housing 30 may be screwed into cylinder head 200, for example. Instead of two laser spark plugs 122a, 122b, if necessary, three or more laser ignition devices could also be combined, so that additional different ignition points are able to be implemented. The present variant of the present invention is particularly simple to implement constructively since, at least with regard to the mechanical arrangement, one is able to fall back on using usual laser spark plugs 122a, 122b.

An additional degree of freedom for the laser ignition according to the present invention, in precombustion chamber 110, is given in that laser ignition spark plugs 122a, 122b, or focusing optical systems included in them, for collimating laser radiation 24a, 24b have different focal lengths.

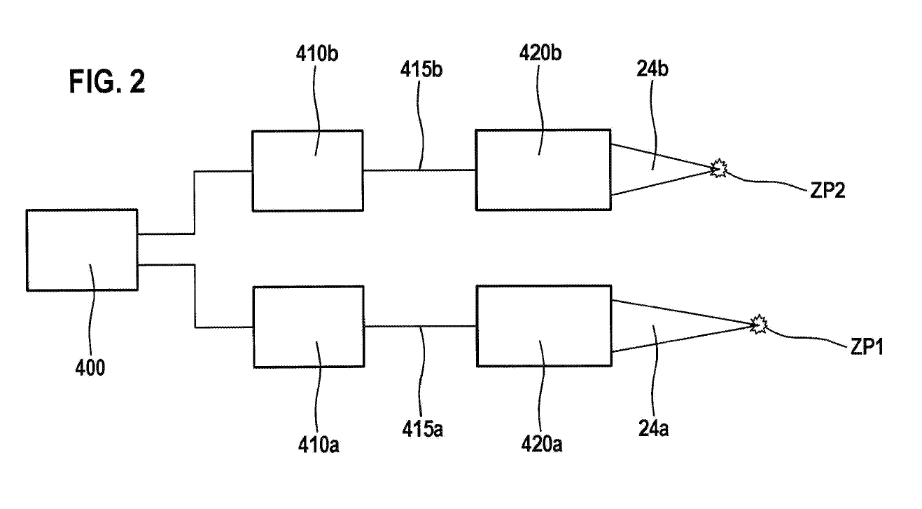

FIG. 2 shows schematically a block diagram, which gives a control principle for laser ignition device 100, according to the present invention. An engine controller 400, which could, for instance, also take over fuel injection and additional control or regulation tasks for the operation of the internal combustion engine, activates two pump lasers 410a, 410b.

Pump lasers 410a, 410b may be developed as semiconductor laser diodes, for example, which are actuated via an electrical actuation current. The intensity of the laser radiation emitted by pump lasers 410a, 410b depends directly on the actuation current, among other things. The laser radiation generated by pump lasers 410a, 410b is supplied to ignition lasers 420a, 420b.

Ignition lasers 420a, 420b may be passively Q-switched solid lasers, for example, each having a laser-active solid and an associated passive Q-switch. Because of the action of ignition lasers 420a, 420b using the laser radiation generated by pump lasers 410a, 410b, energy-rich laser ignition pulses 24a, 24b may thus be generated by the ignition lasers 420a, 420b. For the purpose of focusing laser ignition pulses 24a, 24b on a desired ignition point ZP1, ZP2, focusing optics having the appropriate focal length are assigned to each ignition laser 420a, 420b.

The first ignition laser 420a of FIG. 2 and its associated focusing optics may be included in laser spark plug 122a of FIG. 1, while second laser spark plug 122b according to FIG. 1 has second ignition laser 420b of FIG. 2 and a focusing optics assigned to it.

Pump lasers 410a, 410b are preferably situated removed from laser ignition device 100, for instance close to engine controller 400. An integration of pump lasers 410a, 410b into engine controller 400 is also possible. Pump lasers 410a, 410b may also be combined in a common pump module. Using light conductor devices 415a, 415b, laser ignition spark plugs 122a, 122b are supplied with the laser radiation, required for the optical pumping of ignition lasers 420a, 420b by pump lasers 410a, 410b.

Engine controller 400, for instance, as a function of a characteristics map, is able to set different actuating current curves over time, and thus, appropriate pump profiles for the optical pumping of ignition lasers 420a, 420b, so that the laser ignition in precombustion chamber 110 takes place depending on the operating point of the internal combustion engine at a single, or even at multiple ignition points ZP1, ZP2. The sequence in time of the action upon individual ignition points ZP1, ZP2 is also able to be specified by engine controller 400. Ignition may take place, both simultaneously at a plurality of ignition points ZP1, ZP2, and offset in time at a plurality of ignition points ZP1, ZP2 or at individual ignition points.

Because of the control of laser ignition device 100 described above, the torch length, in particular, of ignition torches 116a, 116b (FIG. 1) is able to be controlled as a function of an operating point of the internal combustion engine.

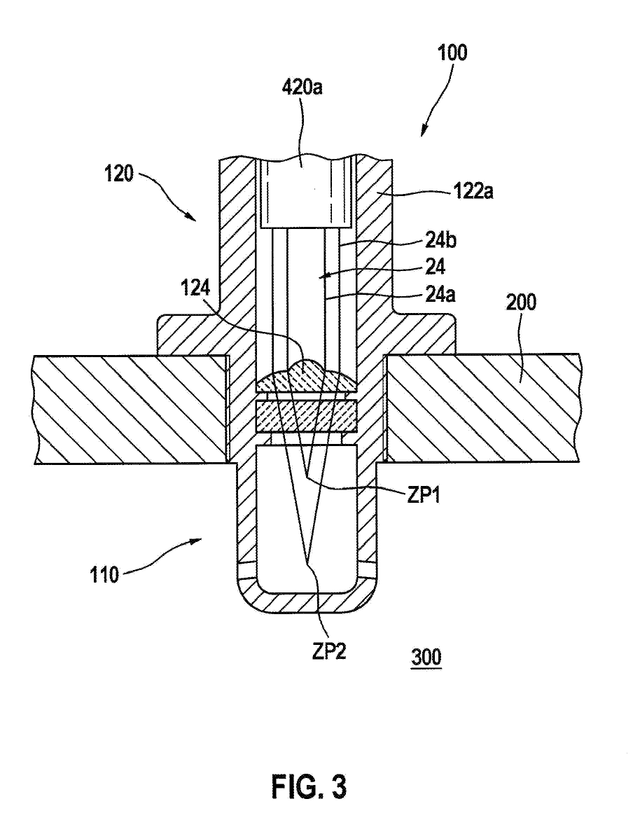

FIG. 3 shows an end section of a second specific embodiment of laser ignition device 100 according to the present invention, that faces the combustion chamber. This variant of the present invention provides only one laser spark plug 122a for laser device 120. In order to be able, nevertheless, to implement two different ignition points ZP1, ZP2 in precombustion chamber 110, laser device 120 according to FIG. 3 has bifocal focusing optics 124. Bifocal focusing optics 124 collimates laser radiation 24 generated by laser device 120, as a function of the beam cross section, in the present case particularly of the beam diameter, to different ignition points ZP1, ZP2. An epipolar beam 24a is collimated by the first curvature range of focusing optics 124 to first ignition point ZP1, while a jacketing beam 24b is collimated by a second curvature range of focusing optics 124 to second ignition point ZP2.

The effect of the beam profile of laser radiation 24, which in the present case controls the selection of ignition points ZP1, ZP2, may take place in a manner known per se, for instance, by adjacently arranged ignition lasers 420a, 420b, which are presently integrated in laser spark plug 122a, and are actuated as required.

Alternatively, only one ignition laser 420a may be integrated in laser spark plug 122, and laser device 120 may be configured so that at moderate pumping light power at ignition laser 420a, a smaller beam diameter is created than at a higher pumping power. In this case, the selection of ignition points ZP1, ZP2 may take place, accordingly, by specifying the intensity of the laser beam used for the optical pumping of ignition laser 420a.

This may occur, for example, in that, at small pumping power, the beam density is great enough only in the middle of the beam cross section (e.g. Gaussian profile) in order to switch through the solid laser using its passive Q-switch, only where an ignition laser beam having a small diameter is created, compared to the use of higher pumping powers, in which the Q-switch is switched through over the entire pumping beam cross section, and thus an ignition beam is created that has a full cross section. The pumping power is able to be controlled via the current of the pumping laser (semiconductor laser).

The principle, according to the present invention, of the optionally controllable local laser ignition in precombustion chamber 110, advantageously makes possible influencing the torch range of ignition torches 116a, 116b (FIG. 1), so that, even at different degrees of filling of precombustion chamber 110, generally equal torch ranges may be achieved, for example.

1-8. (canceled)

9. A laser ignition device for an internal combustion engine, comprising:
a precombustion chamber; and
a laser device to focus laser radiation onto at least two ignition points lying in the precombustion chamber that are different from each other, the laser device to irradiate the laser radiation optionally onto one or more ignition points.

10. The laser ignition device as recited in claim 9, wherein the laser device is irradiates the laser radiation simultaneously onto a plurality of ignition points.

11. The laser ignition device as recited in claim 9, wherein the laser device has at least two laser spark plugs.

12. The laser ignition device as recited in claim 11, wherein the at least two laser spark plugs have different focal lengths.

13. The laser ignition device as recited in claim 11, wherein the laser device has at least one bifocal focusing optics.

14. A method for operating a laser ignition device for an internal combustion engine, having a precombustion chamber and a laser device, the laser device to irradiate laser radiation onto at least two ignition points, lying in the precombustion chamber; that are different from each other, the method comprising:
irradiating the laser radiation optionally onto one or more ignition points.

15. The method as recited in claim 14, wherein the irradiation of the laser radiation onto the one or more ignition points is carried out as a function of an operating point of the internal combustion engine.

16. The method as recited in claim 14, wherein the laser radiation is irradiated simultaneously onto a plurality of ignition points.
